(19) United States
(12) Patent Application Publication
(10) Pub. No.: US 2015/0081336 A1
(43) Pub. Date: Mar. 19, 2015

(54) Electrical Computing Devices for Quantification of Differences in Medical Treatment Populations

(71) Applicant: Quintiles Transnational Corporation, Durham, NC (US)

(72) Inventors: Angela Lynn Hill, Carmel, IN (US); Gavin David Thomas Nichols, Cary, NC (US)

(73) Assignee: QUINTILES TRANSNATIONAL CORPORATION, Durham, NC (US)

(21) Appl. No.: 14/490,986

(22) Filed: Sep. 19, 2014

Related U.S. Application Data
(60) Provisional application No. 61/879,877, filed on Sep. 19, 2013.

(51) Int. Cl. G06F 19/00

(52) U.S. Cl. CPC G06F 19/345; G06F 19/322; G06F 19/36
USPC 705/3

(57) ABSTRACT

One disclosed method includes receiving electronic health records (EHRs) associated with a first set of patients for a clinical trial of a health intervention; receiving electronic records representing profiles of patients likely to benefit from the health intervention; determining a first statistic for a first characteristic of the first set of patients and a second statistic for a second characteristic of the patients likely to benefit from the health intervention; and determining a gap in the first set of patients based on the first statistic and the second statistic.

### CROSS-REFERENCE TO RELATED APPLICATION

This claims priority to U.S. Provisional Patent Application No. 61/879,877, titled “Electrical Computing Devices for Quantification of Differences in Medical Treatment Populations” and filed Sep. 19, 2013, the entirety of which is hereby incorporated by reference.

### FIELD

The present disclosure generally relates to electrical computer-implemented systems and methods for quantifying differences between medical treatment populations.

### BACKGROUND

Clinical trials can be performed to assess the safety and efficacy of health interventions, such as drugs, diagnostics, and therapies. Populations of patients participate in the clinical trials and information is gathered from these populations of patients. The information is used to assess the health interventions. The assessment of health interventions can be used to determine whether the health interventions should be approved for use by a general patient population and the restrictions on the types of patients for which the health interventions are approved for use. Differences may exist between characteristics of the clinical trial patient populations and characteristics of the general patient population. identifying and resolving those gaps so that health interventions are available to genera population patients that could benefit from them is challenging.

### BRIEF DESCRIPTION OF THE DRAWINGS

FIG. 1 shows an example of an environment in which certain aspects of electrical computing devices for quantification of differences in medical treatment populations may be implemented;

FIG. 2 shows a block diagram with an example of the computing device; for quantification of differences in medical treatment populations; and

FIG. 3 shows a data flow diagram that depicts an example of certain processes for quantification of differences in medical treatment populations.

### DETAILED DESCRIPTION

Examples are described herein in the context of electrical computing devices for quantification of differences in medical treatment populations. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Certain aspects relate to electronic computing systems and database structures for quantifying differences between randomized clinical trial populations and general patient populations using electronic health records and clinical trial records. Potential gaps in clinical trials can be identified using characteristics of randomized clinical trial populations and characteristics of patient populations generated through electronic analysis of structured data sets that include electronic health records. Statistical analysis of the potential gaps using this information can produce statistics usable in identifying and addressing the potential gaps so that a “real world” patient that needs a health intervention can have access to it faster or that a provider of this patient can properly monitor the patient's use of the health intervention.

Certain aspects relate to a repeatable, sustainable methodology for providing knowledge-based, data-driven insights into the relationship between patients participating in a clinical trial in order to get a drug or other health intervention to market and information to those who receive it after it is on the market. Statistical models and analytical tools can characterize and quantify the nature of the relationship in terms of similarities and differences so that potential impacts or gaps can be determined. Using certain aspects of the present disclosure can decrease or eliminate inherent bias in the analysis and reduce the amount of time that a “real world” patient that would benefit from a heath intervention to, in fact, benefit from that health intervention by it being approved faster for use for types of patients in which that patient is a member.

In some aspects, separate structured data sets from electronic health records and randomized controlled clinical trial records can be bought together in a repeatable, predictable way such that insights can be derived by comparing certain data from these separate structured data sets. For example, drugs or other health interventions may not affect all patients equally. Acutely ill patients may notice dramatic improvements while moderately ill patients may experience no effect from the health intervention. Patients of one race may respond better than patients of a different race. The types of patients that will receive the health intervention after it is on the market can be predicted or otherwise received. By bringing together electronic health records and randomized controlled clinical trial records, characteristics (e.g., subpopulations) of patients that will benefit from the health intervention can be determined and compared to characteristics of patients that participated in the clinical trial for the health intervention. Potential gaps in the clinical trial can be identified and proactively addressed. For example, patients that would benefit from the health intervention may have a certain characteristic not shared with any of the clinical trial participants, or shared with a statistically insignificant number. Identifying that potential gap may result in the health intervention being available faster to those patients or providers (i.e., medical physicians treating “real world” patients) can take precautions in prescribing the health intervention to patients within that subpopulation.

By way of example, drug A is renally eliminated and causes nausea and vomiting in overdose. The incidence of this was low in the patients participating in the clinical trial, but only a relatively small number of those clinical trial patients were sixty-five years of age or older. Through analyzing electronic health records, the majority of patients between sixty and seventy-five years of age are predicted to receive drug A once it is available on the market. Systems according to some aspects can be used to understand that there is a potential for nausea and vomiting in patients within this subpopulation due to age-related decreased renal clearance, and therefore accumulation of drug A. Regulators, payers, and providers can benefit from having this data and insight, and can act accordingly.

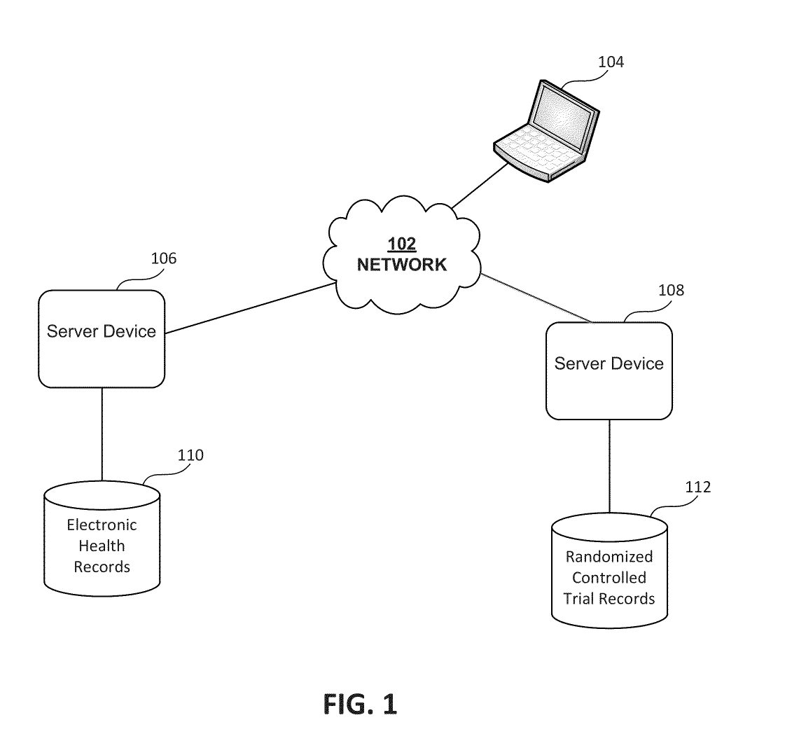

FIG. 1 is an example of an environment in which certain aspects may be implemented. The environment includes a network 102, a computing device 104, server devices 106, 108, an electronic health records data storage device 110, and a randomized controlled clinical trial records storage device 112. The computing device 104 can communicate through the network 102, which may be one or more networks, with these other devices. The server devices 106, 108 may be database server devices that provide access to structured data sets in the electronic health records data storage device 110 and the randomized controlled clinical trial records storage device 112, respectively, to the computing device 104 through the network 102.

The electronic health records data storage device 110 may be a database in which structured data sets of health information and demographic information of patients treated by physicians are stored electronically. In some aspects, the electronic health records can contain health-related information about at least a majority of individuals living within political boundary, such as country or state within a country, that have been treated by physicians. The randomized controlled clinical trial records storage device 112 may be a database in which health information and demographic information of patients participating (or who have participated) in clinical trials are electronically stored and electronically associated with clinical trial information that may include protocol and health intervention identification. The health information can include laboratory results, vitals, drug treatments, past drug treatments, health complaints, health conditions, diseases, etc. The demographic information can include age, race, sex, marital status, location, etc.

The computing device 104 can receive data from the electronic health records data storage device 110 and the randomized controlled clinical trial records storage device 112 as electronic, optical, or wireless signals through server devices 106, 108 and the network 102. The network 102 may be any suitable network. Examples of suitable networks include the Internet, an intranet, local area network, wireless local area network, wide area network, microwave network, satellite network, Integrated Services Digital Network, cellular network, and combinations of these or other types of networks. The computing device 104 can bring the data together to identify potential gaps and generate statistics about the potential gaps for display on a user interface.

Although depicted separately, the server device 106 may include the electronic health records data storage device 110 and the server device 108 may include the randomized controlled clinical trial records storage device 112. In some aspects, the computing device 104 includes one or both of the electronic health records data storage device 110 and the randomized controlled clinical trial records storage device 112, and the environment does not include one or more of the server devices 106, 108 or the network 102. In other aspects, one of the server devices 106, 108 includes the computing device 104.

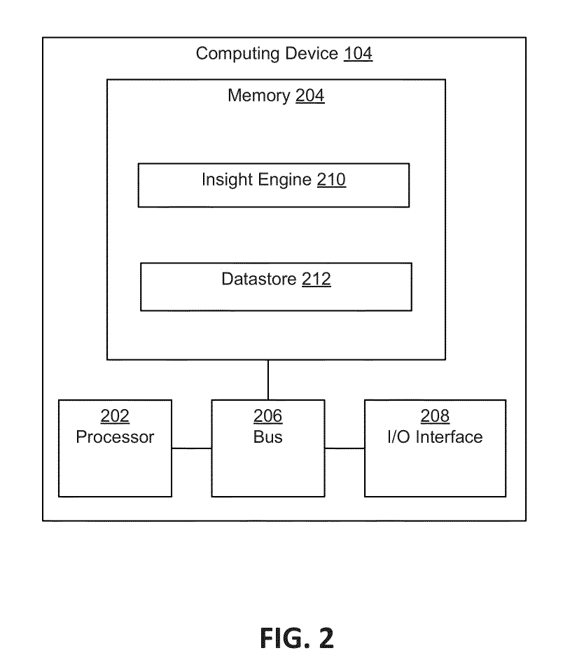

FIG. 2 depicts a block diagram with an example of the computing device 104. Other examples may of course be utilized. The computing device 104 includes a processor 202, a memory 204, and a bus 206. The memory 204 includes a tangible computer-readable memory on which code is stored. The processor 202 can execute code stored in the memory 204 by communication via the bus 206 to cause the computing device 104 to perform actions. The computing device 104 can include an input/output (I/O) interface 208 for communication with other components, such as the network 102 and server devices 106, 108 of FIG. 1. The computing device 104 may be any device that can electronically process data and execute code that is a set of instructions to perform actions. Examples of the computing device 104 include a database server, a web server, desktop personal computer, a laptop personal computer, a handheld computing device, and a mobile device.

Examples of the processor 202 include a microprocessor, an application-specific integrated circuit (ASIC), a state machine, or other suitable processor. The processor 202 may include one processor or any number of processors. The processor 202 can access code stored in the memory 204 via the bus 206. The memory 204 may be any non-transitory computer-readable medium configured for tangibly embodying code and can include electronic, magnetic, or optical devices. Examples of the memory 204 include random access memory (RAM), read-only memory (ROM), a floppy disk, compact disc, digital video device, magnetic disk, an ASIC, a configured processor, or other storage device.

Instructions can be stored in the memory 204 as executable code. The instructions can include processor-specific instructions generated by a compiler, an interpreter, or both, from code written in any suitable computer-programming language. The instructions can include an application, such as an insight engine 210, that, when executed by the processor 202, can cause the computing device 104 to analyze data from separate sources, identify potential gaps, and generate user interfaces with statistics about those potential gaps. The memory 204 can also include a datastore 212 in which content and data can be stored.

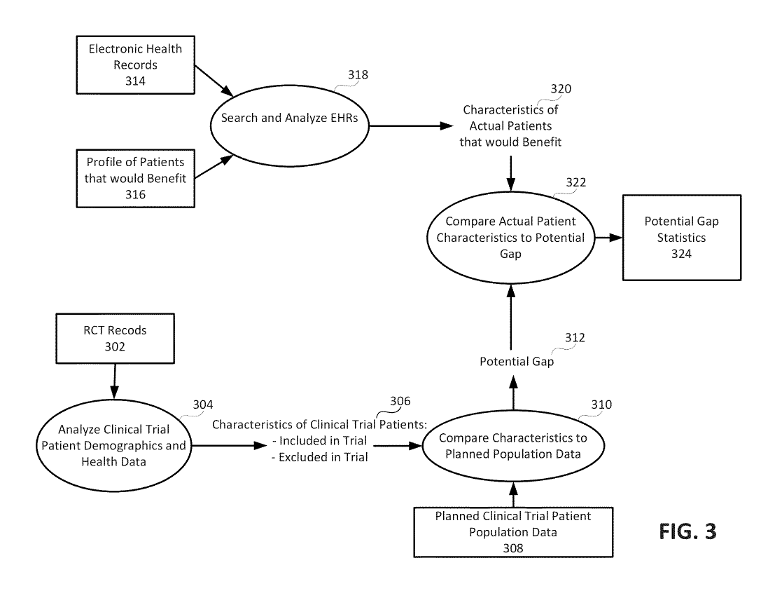

FIG. 3 is a data flow diagram that depicts an example of certain processes that can be performed by the computing device 104 of FIGS. 1-2. The computing device 104 can receive for a clinical trial randomized controlled clinical trial (labeled “RCT”) records from the randomized controlled clinical trial records storage device 112 of FIG. 1. The computing device 104 can analyze clinical trial patient demographics and health data 304 in the RCT records to determine characteristics of the clinical trial patients 306. For example, the computing device 104 can sort the clinical trial patient demographics and health data 304 to extract characteristics specified by a user or pre-configured in the computing device 104. The characteristics of the clinical trial patients 306 can include information about patients included in the clinical trial and information about patients, or potential patients, excluded from the clinical trial.

The computing device 104 can receive planned clinical trial patient population data 308 from the randomized controlled clinical trial records storage device 112, the local data store 212, or from user input. The planned clinical trial patient population data 308 can include information about the desired characteristics of a patient population for the clinical trial during a planning stage of the clinical trial. The computing device 104 can compare the characteristics of clinical trial patients 306 to the planned clinical trial patient population data 308 to determine a potential gap 312 for the clinical trial being analyzed. The potential gap 312 may indicate, for example, that the clinical trial patient population has fewer patients than planned for patients that have a specific demographic or health condition. Based on the potential gap, in some aspects, a computing device can identify additional or different patients to be included in the planned clinical trial patient population.

The computing device 104 can receive electronic health records 314 from the electronic health records data storage device 110. The computing device 104 can also receive a profile of patients that would benefit from the health intervention for which the clinical trial is being conducted 316. The profile can be received from user input or automatically generated by statistically analyzing pre-clinical trial data about the health intervention. The profile can include patient demographic or health criteria of patients for which the health intervention would be (or could be) used to treat. The computing device 104 can search and analyze electronic health records 318 using the profile to determine characteristics of actual patients that would benefit from the health intervention 320.

The computing device 104 can compare 322 actual patient characteristics that would benefit from the health intervention 320 to the potential gap 312 to provide potential gap statistics 324 that can indicate potential gaps in the clinical trial. The statistics can be displayed on a user interface. Differences between the clinical trial population and actual patients that might benefit can be analyzed to determine whether the differences matter or to determine information and processes to resolve the differences.

In one aspect, an electronic computing system is provided. The electronic computing system can analyze clinical trial records and electronic health records to identify potential gaps in a clinical trial for a health intervention. The electronic computing system can analyze the records using planned clinical trial patient population data and profiles of patients that would benefit from the health intervention. The potential gaps can be used to address issues that prevent actual patients that would benefit from a health intervention from receiving the health intervention, or otherwise receiving the health intervention effectively.

While this specification contains many specifics, these should not be construed as limitations on the scope or of what may be claimed, but rather as descriptions of features specific to particular aspects. Certain features that are described in this specification in the context or separate aspects can also be implemented in combination in a single implementation. Conversely, various features that are described in the context of a single implementation can also be implemented in multiple ways separately or in any suitable subcombination. Moreover, although features may be described above as acting in certain combinations, one or more features from a combination can in some cases be excised from the combination, and the combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or device, or packaged into multiple software products or devices.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines, Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation Any particular feature, structure, operation, or other characteristic described in this specification in relation to one example or implementation may be combined with other features, structures, operations, or other characteristics described in respect of any other example or implementation.

That which is claimed is:

1. A method comprising:
receiving, by one or more electronic computing devices, electronic health records (EHRs) associated with a first set of patients for a clinical trial of a health intervention;
receiving, by one of the electronic computing devices, electronic records representing profiles of patients likely to benefit from the health intervention;
determining, by one of the electronic computing devices, a first statistic for a first characteristic of the first set of patients and a second statistic for a second characteristic of the patients likely to benefit from the health intervention; and
determining, by one of the electronic computing devices, a gap in the first set of patients based on the first statistic and the second statistic.

2. The method of claim 1, wherein the determining the first statistic for the first characteristic of the first set of patients comprises determining a plurality of statistics for a plurality of characteristics of the first set of patients.

3. The method of claim 1, wherein the determining the second statistic for the second characteristic of the patients likely to benefit from the health intervention comprises determining a plurality of statistics for a plurality of characteristics of the patients likely to benefit from the health intervention.

4. The method of claim 1, further comprising:
determining a set of first statistics for the first set of patients;
determining a set of second statistics for the patients likely to benefit from the health intervention; and
determining a plurality of gaps in the first set of patients based on the set of first statistics and the set of second statistics.

5. The method of claim 1, wherein the characteristic of the first set of patients and the corresponding characteristic of the patients likely to benefit from the health intervention comprises an age or an age range.

6. The method of claim 1, further comprising identifying one or more additional patients to be included in the first set of patients based on the gap.

7. The method of claim 1, further comprising displaying a representation of the gap.
